(19) United States
(12) Patent Application Publication
(10) Pub. No.: US 2020/0232400 A1
(43) Pub. Date: Jul. 23, 2020

(54) METHOD FOR THE REGENERATION OF AN ACTIVATED CARBON FILTER, AS WELL AS INTERNAL COMBUSTION ENGINE

(71) Applicant: VOLKSWAGEN AKTIENGESELLSCHAFT, Wolfsburg (DE)

(72) Inventors: Jens WODAUSCH, Braunschweig (DE); Björn FRÖHLICH, Gifhorn (DE)

(73) Assignee: VOLKSWAGEN AKTIENGESELLSCHAFT, Wolfsburg (DE)

(21) Appl. No.: 16/743,159

(22) Filed: Jan. 15, 2020

(30) Foreign Application Priority Data
Jan. 17, 2019 (DE) 10 2019 101 181.7

(51) Int. Cl. F02D 41/00; F02M 25/08; F02M 61/14

(52) U.S. Cl. CPC F02D 41/0007; F02M 25/0854; F02M 61/145; F02M 25/0836

(57) ABSTRACT

The invention relates to an internal combustion engine having an intake system and a fuel tank. In the intake system, there is a compressor and, downstream from the compressor, there is a throttle valve. The intake system comprises an air supply line that connects the compressor to an inlet of the internal combustion engine. The fuel tank has a venting line that connects the fuel tank to an activated carbon canister containing an activated carbon filter. It is provided for a conveying line to branch off from the air supply line and to connect the air supply line downstream from the compressor and upstream from the throttle valve to an intake line downstream from an air filter and upstream from the compressor. It is likewise provided for a control valve and a Venturi nozzle to be arranged in the conveying line, whereby the activated carbon canister is connected via a first flushing line to the air supply line downstream from the throttle valve and upstream from the inlet of the internal combustion engine, and whereby the activated carbon canister is connected via a second flushing line to the Venturi nozzle in the conveying line.

### FIELD OF THE INVENTION

The invention relates to a method for the regeneration of an activated carbon filter in the tank venting system of a fuel tank of an internal combustion engine and it also relates to an internal combustion engine for carrying out such a method according to the generic part of the independent patent claims.

### BACKGROUND OF THE INVENTION

As a function of the pressure and temperature in a fuel tank, it can happen that a certain portion of the fuel evaporates and mixes with the air present in the fuel tank. In order for fuel to be filled into the tank when a motor vehicle is being fueled, the air present in the fuel tank has to escape from the tank. For this purpose, a tank venting line is provided which allows air to flow out of the fuel tank. With an eye towards preventing fuel vapors from getting into the environment in this manner, it is a known procedure to arrange in the tank venting line an activated carbon filter that binds the fuel vapors. In order to regenerate the activated carbon filter, it is a known approach to connect the activated carbon filter to the intake system of the internal combustion engine via a connection line so that the fuel vapors trapped in the activated carbon filter enter the intake system of the internal combustion engine, where they mix with fresh air and are then reacted in the combustion chambers of the internal combustion engine. A known alternative consists of connecting the activated carbon filter to the exhaust gas system of the internal combustion engine, whereby the fuel constituents trapped in the activated carbon filter are converted into carbon dioxide and water by the exhaust gas aftertreatment components of the internal combustion engine. In this context, the goal is to flush the activated carbon filter as often as possible, as a result of which the average flushing rate is higher than the amount of evaporating fuel components in the fuel tank. In order to make flushing of the activated carbon filter possible, an appropriate pressure gradient, which is also referred to as a flushing gradient, has to be present so that an air flow is conveyed through the activated carbon filter and the unburned hydrocarbons are flushed out of the activated carbon filter.

German patent specification 10 2011 084 539 B1 discloses an internal combustion engine with an exhaust gas turbocharger whose housing has an inlet area connected to a low-pressure inlet and an outlet area connected to a high-pressure outlet. In this context, the inlet area is connected to the low-pressure side of an intake pipe while the outlet area is connected to the high-pressure side of the intake pipe. The compressor of the exhaust gas turbocharger has a Venturi nozzle that is arranged between the outlet area and the inlet area and that is connected to an activated carbon filter for venting purposes. Moreover, a diverter valve is provided on the compressor, whereby the activated carbon filter is vented when the diverter valve is open.

German patent application DE 10 2012 200 583 A1 discloses a tank venting system for an internal combustion engine, whereby the internal combustion engine has an intake system in which a compressor is arranged. The compressor has a bypass that is connected to a fuel system, whereby a valve that controls the air mass that can flow through the bypass as a function of the load is arranged in the bypass.

Moreover, international patent application WO 2015/185 303 A1 discloses a charged internal combustion engine with an intake system, whereby a throttle element is arranged in the intake system between a compressor and the internal combustion engine. Via a diverter valve, the intake system is connected on the low-pressure side to a first line and on the high-pressure side to a second line between the compressor and the throttle element so as to convey gas. A fuel tank with an activated carbon filter is provided that serves to supply fuel to the internal combustion engine, whereby, via the tank venting valve, the intake system is connected on the low-pressure side to a third line and on the high-pressure side to a fourth line between the compressor and the throttle element. In this context, it is provided for the diverter valve and the tank venting valve to be arranged parallel to each other in terms of the flow and for the first and third lines as well as the second and fourth lines to be the same lines, at least in some sections.

Before this backdrop, the invention is based on the objective of improving the ability to regulate the flushing air volume and to supply the flushing air flow, especially irrespective of the geodetic altitude at which the internal combustion engine is being operated.

### SUMMARY OF THE INVENTION

According to the invention, this objective is achieved by an internal combustion engine having an intake system and a fuel tank. In this context, the intake system comprises an intake line that connects an air filter to a compressor. Moreover, the intake system comprises an air supply line that connects the compressor to an inlet of the internal combustion engine. A throttle valve with which the air feed to the combustion chambers of the internal combustion engine can be regulated is arranged in the air supply line. The fuel tank has a venting line that connects the fuel tank to an activated carbon canister containing an activated carbon filter. The provision is made for a conveying line that branches off from the air supply line and that connects the air supply line downstream from the compressor and upstream from the throttle valve to the intake line downstream from the air filter and upstream from the compressor. It is also provided for a control valve and a Venturi nozzle to be arranged in the conveying line, whereby the activated carbon canister is connected via a first flushing line to the air supply line downstream from the throttle valve and upstream from the inlet of the internal combustion engine, and whereby the activated carbon canister is connected via a second flushing line to the Venturi nozzle in the conveying line. With an internal combustion engine according to the invention, it is possible to maintain full engine power and, at the same time, to feed a maximum venting flow through the activated carbon filter so that the fuel vapors trapped in the activated carbon filter can be fed, at least indirectly, to the combustion chambers of the internal combustion engine, a process in which the activated carbon filter is regenerated.

The features put forward in the dependent claims yield advantageous improvements and non-trivial refinements of the internal combustion engine cited in the independent claim.

In a preferred embodiment of the invention, it is provided for the control valve to be arranged in the conveying line upstream from the Venturi nozzle. In this context, the mass flow conveyed through the Venturi nozzle is regulated by the control valve. Here, the first flushing flow through the first flushing line is regulated by means of the tank venting valve.

As an alternative, it is advantageously provided for the control valve to be arranged in the conveying line downstream from the Venturi nozzle. In this context, the tank venting valve in the shared section of the two flushing lines can regulate both of the tank venting mass flows, whereby the distribution of the tank venting mass flows is brought about by the appertaining pressure gradients in the flushing lines.

In an advantageous embodiment of the invention, it is provided for the compressor to be configured as an electrically or mechanically driven compressor. An electrically driven compressor allows a particularly fast and precise regulation of the compressor rotational speed and of the compressor mass flow. As a result, the pressure gradient over the conveying line and thus the volume flow can be exactly set by means of the Venturi nozzle. An appertaining pressure gradient over the conveying line can likewise be set by a mechanically driven compressor, but it cannot be adjusted in the case of a mechanical compressor because of the direct coupling with the rotational speed of the internal combustion engine.

In another preferred embodiment of the invention, it is provided for the internal combustion engine to be charged by means of an exhaust gas turbocharger, whereby the compressor is driven by a turbine situated in an exhaust gas channel of the internal combustion engine. By means of an exhaust gas turbocharger, at least a portion of the energy contained in the exhaust gas stream can be utilized to improve the filling of fresh air into the combustion chambers of the internal combustion engine. In this process, the compressor creates a pressure gradient over the conveying line, bringing about a conveying flow through the Venturi nozzle. This conveying flow can be set and adjusted by the control valve in order to attain the best possible compromise between the maximum power of the internal combustion engine and the largest possible tank venting mass flow.

In this context, it is especially preferred for the turbine to have an electrically regulated wastegate via which an exhaust gas stream can bypass the turbine of the exhaust gas turbocharger. An electric wastegate allows a very fast regulation of the exhaust gas turbocharger. In this manner, unfavorable operating states can be avoided in which the compressor is operated close to its pumping limit, something which could cause pressure fluctuations and damage to the turbine of the exhaust gas turbocharger.

In a preferred embodiment of the invention, it is provided for the first flushing line and the second flushing line to have a shared line section, whereby a tank venting valve is arranged in the shared line section of the two flushing lines. Thanks to the tank venting valve being situated in a shared section of the flushing lines, it is particularly easy to control the tank venting mass flow. In this context, the tank venting valve is preferably configured as an electrically switchable valve that can be actuated by means of the engine control unit of the internal combustion engine in order to achieve fast switching times and the most exact regulation of the tank venting mass flow possible.

In another improvement of the invention, it is provided for a first non-return valve to be arranged in the first flushing line and for a second non-return valve to be arranged in the second flushing line. Non-return valves can prevent fresh air from being introduced in the direction of the activated carbon filter via the flushing lines. In this context, the non-return valves are preferably configured as passive valves in order to reduce the costs of the system.

As an alternative, it is advantageously provided for a tank venting valve to be arranged in the first flushing line downstream from a branch of the first flushing line leading out of the second flushing line as well as upstream from the feed site of the first flushing line leading into the air supply line. This variant, in conjunction with a control valve downstream from the Venturi nozzle, makes it possible to dispense with the non-return valves. In this context, the function of the non-return valve in the first flushing line is provided by the tank venting valve, while the function of the non-return valve in the second flushing line is provided by the control valve. The closure of the valves likewise ensures in an operationally reliable manner that no fresh air can flow out of the intake system and into the activated carbon filter.

In another alternative, it is provided for the activated carbon canister to be connected via a first flushing line to the air supply line downstream from the throttle valve and upstream from the inlet of the internal combustion engine, and for it to be connected via a second flushing line to the Venturi nozzle in the conveying line, whereby the first flushing line and the second flushing line run separately from each other along their entire lengths, whereby a tank venting valve is arranged in the first flushing line. Redundancy can be achieved by means of the two separate flushing lines, so that, even if one of the flushing lines is closed, the activated carbon canister can still be flushed, and the activated carbon filter can thus be regenerated.

According to the invention, a method for the regeneration of an activated carbon filter in a tank venting system of a fuel tank of an internal combustion engine according to the invention is being put forward, whereby the throttle valve generates a negative pressure by means of which a first flushing flow is initiated which feeds the fuel vapors that were trapped in the activated carbon filter into the air supply line downstream from the throttle valve and upstream from the inlet, and whereby the Venturi nozzle initiates a second flushing flow which feeds the fuel vapors trapped in the activated carbon filter into the intake line downstream from the air filter and upstream from the compressor. The method according to the invention can provide a maximum tank venting mass flow in order to flush out the greatest possible amount of fuel vapors trapped in the activated carbon filter and in order to regenerate the activated carbon filter.

In an advantageous embodiment of the method, it is provided for the flushing quantity of the second flushing flow to be adjusted by means of the control valve. Thanks to the control valve, a simple Venturi nozzle with an unvarying cross-sectional course can be used. In this context, the opening angle of the Venturi nozzle can be dimensioned for the greatest possible tank venting mass flow on the basis of the pressure differential that is to be expected over the conveying line.

In an advantageous improvement of the method, it is provided for the rotational speed of the exhaust gas turbocharger to be raised in order to increase the flushing quantity of the second flushing flow. In this process, the altitude reserve of the exhaust gas turbocharger can be at least partially utilized to provide an appropriate conveying volume flow through the conveying line, in addition to supplying the combustion chambers of the internal combustion engine with compressed fresh air.

In another improvement of the method, it is provided for a reserve area RB of the exhaust gas turbocharger to be used to effectuate an increase in the flushing mass flow as a function of the flushing demand and, at the same time, to actuate the control valve in such away that the requested additional flushing quantity is systematically assigned to the flushing mass flow.

In a preferred embodiment of the invention, it is provided for the tank venting valve to control the first flushing flow. If the tank venting valve is arranged in a shared section of the two flushing lines, then both flushing flows are dependent on the position of the tank venting valve. However, if the tank venting valve is arranged in the first flushing line downstream from the branch, or if two separate flushing lines are provided and the tank venting valve is arranged in the first flushing line, then it is possible to control the amount of fuel vapor that is fed to the intake system downstream from the throttle valve and upstream from the inlet of the internal combustion engine.

Unless otherwise indicated in an individual case, the various embodiments of the invention put forward in this application can be advantageously combined with each other.

### BRIEF DESCRIPTION OF THE DRAWINGS

The invention will be explained below in embodiments on the basis of the accompanying drawings. The following is shown:

FIG. 1 is a first embodiment of an internal combustion engine according to the invention, with a fuel tank, an intake system and an exhaust gas system;

FIG. 2 is an alternative embodiment of an internal combustion engine according to the invention, with a fuel tank, an intake system and an exhaust gas system;

FIG. 3 is a preferred embodiment of an internal combustion engine according to the invention, with a fuel tank, an intake system and an exhaust gas system;

FIG. 4 is a diagram depicting the rotational speed of the exhaust gas turbocharger as a function of the charge pressure; and

FIG. 5 is a diagram depicting the mass flow through the Venturi nozzle as a function of the reserve quantity and as a function of the opening angle of the Venturi nozzle.

### DETAILED DESCRIPTION OF THE INVENTION

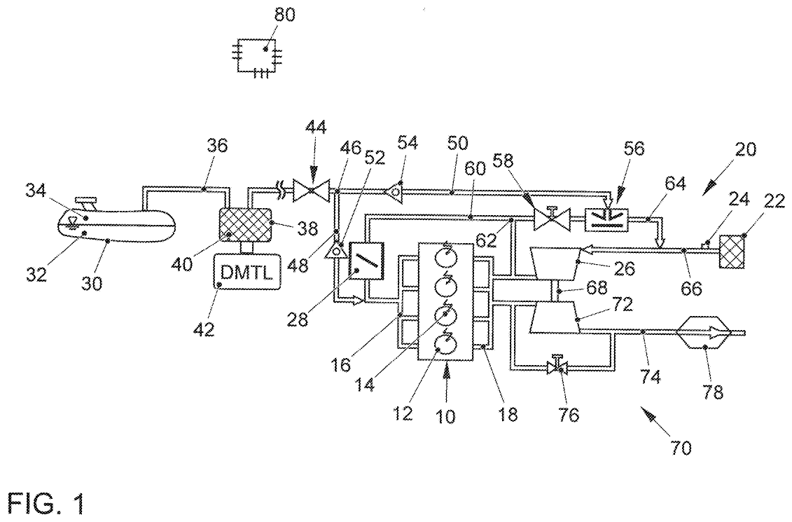

FIG. 1 shows an internal combustion engine 10 with several combustion chambers 12. The internal combustion engine 10 is preferably configured as a gasoline engine. The internal combustion engine 10 can be operated with a fuel 32 that is stored in a fuel tank 30 of a motor vehicle. The fuel tank 30 can be filled through a filler neck and it is equipped with a filling level sensor to detect the filling level. A fuel pump feeds the fuel 32 to the internal combustion engine 10 via a fuel line that branches off from the fuel tank 30, where the fuel is injected into the combustion chambers 12 of the internal combustion engine 10 by means of a fuel injection system. A spark plug 14 is arranged on each combustion chamber 12 in order to ignite the air-fuel mixture in the combustion chambers 12. The internal combustion engine 10 is connected via its inlet 16 to an intake system 20 of the internal combustion engine 10, thus supplying the combustion chambers 12 with fresh air. Fresh air that has been drawn in from the environment is fed to the internal combustion engine 10 via the intake system 20 and it is then made available via an intake line 66 and an air supply line 60 to an inlet 16 that distributes the fresh air to the combustion chambers 12 of the internal combustion engine 10. Arranged in the intake system 20 in the flow direction of the fresh air through the intake system, there is an air filter 22, then downstream from the air filter 22, there is a compressor 26 of the exhaust gas turbocharger 68, and further downstream, there is a throttle valve 28. The air filter 22 is connected to the compressor 26 via an intake line 66. The compressor 26 is connected to the inlet 16 of the internal combustion engine 10 via an air supply line 60. A throttle valve 28 with which the air feed to the combustion chambers 12 of the internal combustion engine 10 can be controlled is arranged in the air supply line 60. A conveying line 64 that connects the intake system 20 downstream from the compressor 26 to the intake line 66 of the intake system 20 downstream from the air filter 22 and upstream from the compressor 26 branches off from the air supply line 60 at a branch 62. A control valve 58 and a Venturi nozzle 56 are arranged in the conveying line. Moreover, in order to determine the quantity of air fed to the compressor 26 of the exhaust gas turbocharger 68, an air mass meter 24 is arranged on the intake line 66 downstream from the air filter and upstream from the place where the conveying line 64 opens up.

The internal combustion engine 10 has an outlet 18 that is connected to an exhaust gas system 70 of the internal combustion engine 10. The exhaust gas system 70 comprises an exhaust gas channel 74 in which, in the flow direction of the exhaust gas of the internal combustion engine 10 through the exhaust gas channel 74, there is a turbine 72 of the exhaust gas turbocharger 68 and, downstream from the turbine 72, there is at least one exhaust gas aftertreatment component 78, especially a three-way catalytic converter or a particulate filter with a three-way catalytically active coating. The exhaust gas turbocharger 68 has a wastegate 76 that forms a bypass for the turbine 72, whereby a valve that serves to control the exhaust gas mass flow through the turbine 72 by means of the wastegate is arranged in the bypass.

The internal combustion engine 10 also has a fuel supply system with a fuel tank 30 in which a liquid fuel 32 is stored. Depending on the pressure and on the ambient temperature, a portion of the fuel 32 can evaporate and remain in the fuel tank 30 as fuel vapor 34. The fuel tank 30 is connected via a venting line 36 to an activated carbon canister 38 in which an activated carbon filter 40 is arranged which binds the fuel vapor and prevents the fuel vapor from escaping into the environment. The activated carbon canister 38 is also connected to a diagnostic module 42 that is capable of detecting a leak in the tank system.

The activated carbon filter 38 is connected via a flushing line 48, 50 to the intake system 20 of the internal combustion engine 10. A tank venting valve 44 is arranged in a first section of the flushing line 48, 50. Downstream from the tank venting valve 44, the flushing line 48, 50 branches off at a branch 46 into a first flushing line 48 and into a second flushing line 50. The first flushing line 48 connects the branch 46 to the air supply line 60 downstream from the throttle valve 28 and upstream from the inlet 16 of the internal combustion engine 10. In the first flushing line 48, there is a first non-return valve 52 that prevents fresh air from flowing back out of the air supply line 60 into the activated carbon canister 38. The second flushing line 50 connects the branch 46 to the Venturi nozzle 56 in the conveying line 64. In this context, in the second flushing line 50, there is a second non-return valve 54 that prevents fresh air from flowing back out of the conveying line 64 into the activated carbon canister 38.

The internal combustion engine 10 is connected to an engine control unit 80 that regulates the quantity of fuel that is metered into the combustion chambers 12 of the internal combustion engine 10. Moreover, the engine control unit 80 actuates the control valve 58 and the tank venting valve 44.

When the control valve 58 is open, a portion of the fresh air compressed by the compressor 26 flows via the conveying line 64 out of the air supply line 60 through the Venturi nozzle 56 back into the intake line 66. In this process, according to the principle of a suction jet pump, the Venturi nozzle 56 conveys a flushing air volume flow out of the activated carbon canister 38. As the altitude and heat increase, this flushing air volume flow cannot be provided to the full extent due to the altitude reserve HR for the exhaust gas turbocharger 68. Use of the control valve 58 can ensure that the flushing air flow is limited as a function of the ambient conditions.

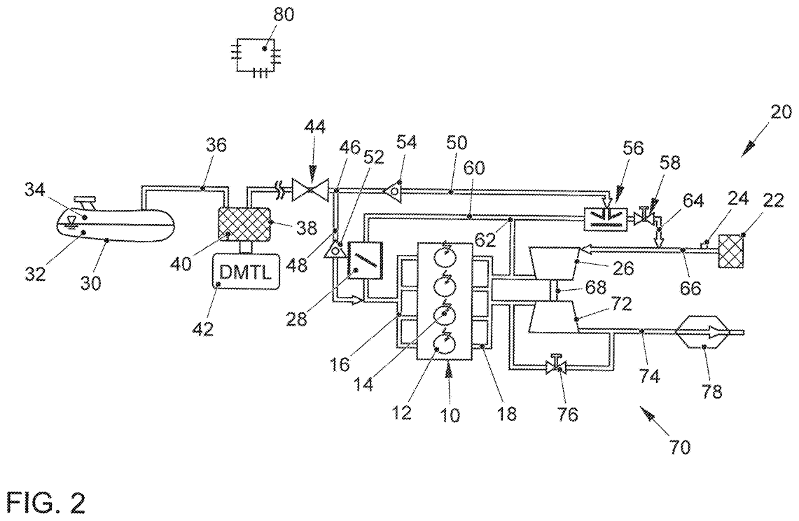

FIG. 2 shows an alternative embodiment of an internal combustion engine 10 having an intake system 20 and an exhaust gas system 70 as well as a fuel tank 30. With an otherwise identical structure as depicted in FIG. 1, the control valve 58 in this embodiment is arranged in the conveying line 64 downstream from the Venturi nozzle 56.

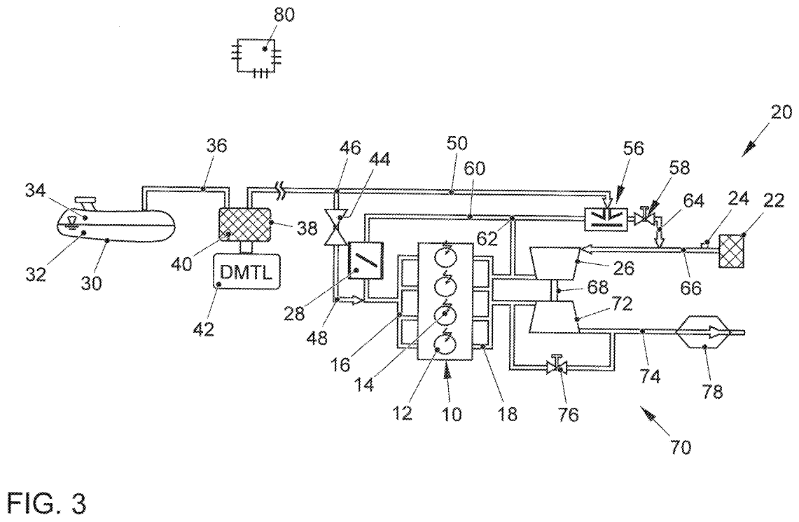

FIG. 3 shows a preferred embodiment of an internal combustion engine 10 having an intake system 20 and an exhaust gas system 70 as well as a fuel tank 30. With an otherwise identical structure to the one depicted in FIG. 1 and FIG. 2, only the differences from these figures will be discussed below. In the embodiment shown in FIG. 3, the tank venting valve 44 is not arranged in the shared flushing line 48, 50 but rather, downstream from the branch 46 in the first flushing line 48. Moreover, the control valve 58 is arranged in the conveying line 64 downstream from the Venturi nozzle 56 and upstream from the place where the conveying line 64 opens up into the intake line 66. As a result, the two non-return valves 52, 54 can be dispensed with. Thanks to the geometric arrangement of the valves 44, 58, maximal regulation dynamics are possible, and this has a positive effect on the mixture formation.

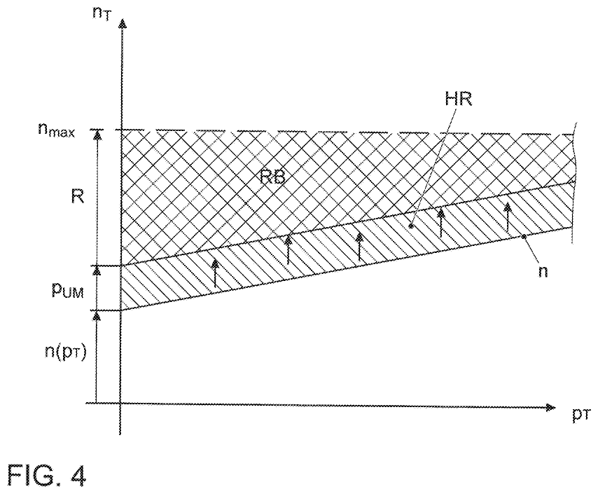

FIG. 4 shows the rotational speed n of the exhaust gas turbocharger 68 as a function of the charge pressure p_{T}. Owing to its structure, the exhaust gas turbocharger 68 has a maximum rotational speed nₘₐₓ. The momentary operating point of the exhaust gas turbocharger 68 and the charge pressure p_{T} needed for this purpose as well as the altitude reserve HR yield a target rotational speed for the exhaust gas turbocharger 68. The difference between this target rotational speed and the maximum rotational speed nₘₐₓ of the exhaust gas turbocharger 68 constitutes the reserve area RB that can be employed to regulate the Venturi nozzle 56. In this context, the reserve area RB of the exhaust gas turbocharger 68 is used to effectuate an increase in the flushing mass flow \tilde{m}_{TE} as a function of the flushing demand. This is especially done by increasing the rotational speed of the exhaust gas turbocharger 68. In the case of an exhaust gas turbocharger 68 with a variable guide geometry for the guide vanes of the turbine 72, this can also be done by adjusting the guide vanes. In particular, however, such an adjustment can help to increase the rotational speed of the exhaust gas turbocharger 68. At the same time, the control valve 58 is actuated in such a way that the requested additional flushing quantity is systematically assigned to the flushing mass flow \dot{m}_{TE}.

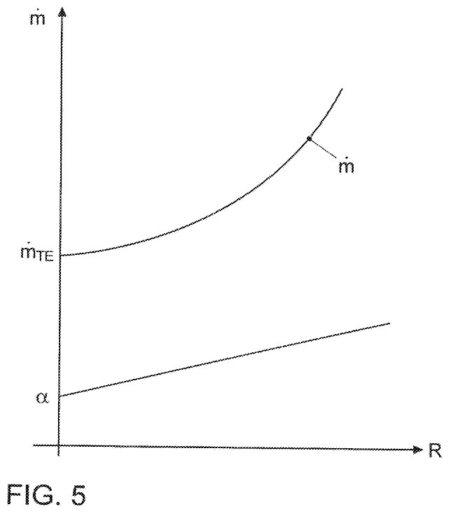

FIG. 5 shows the resultant flushing quantity \dot{m}_{TE} as a function of the mass flow \dot{m} through the Venturi nozzle 56 and as a function of the reserve quantity. Moreover, the mass flow is depicted as a function of the opening angle α of the Venturi nozzle 56. Accordingly, the actuation of the tank venting valve 44 as well as the increase in the rotational speed n of the exhaust gas turbocharger 68 always have to take place as a function of the required flushing quantity.

The tank venting systems being put forward allow full engine power to be maintained, along with the maximum tank venting mass flow. In this process, the activated carbon canister 38 can be flushed in such a way that the activated carbon filter 40 is sufficiently regenerated and the fuel vapors 34 trapped in the activated carbon filter 40 are conveyed in their entirety into the intake system 20. In this manner, a complete regeneration of the activated carbon filter 40 can be achieved and the escape of fuel vapors 34 can be prevented.

### LIST OF REFERENCE NUMERALS

10 internal combustion engine
12 combustion chamber
14 spark plug
16 inlet
18 outlet
20 intake system
22 air filter
24 air mass meter
26 compressor
28 throttle valve
30 fuel tank
32 fuel
34 fuel tank vapor
36 venting line
38 activated carbon filter
40 activated carbon
42 diagnostic module
44 tank venting valve
46 branch
48 first flushing line
50 second flushing line
52 first non-return valve
54 second non-return valve
56 Venturi nozzle
58 control valve
60 air supply line
62 branch
64 conveying line
66 intake line
68 exhaust gas turbocharger
70 exhaust gas system
72 turbine
74 exhaust gas channel
76 wastegate
78 exhaust gas aftertreatment component
80 engine control unit
\dot{m} mass flow
\dot{m}_{TE} resultant flushing quantity
nₘₐₓ maximum rotational speed limit for the exhaust gas turbocharger
n_{T} rotational speed of the turbine of the exhaust gas turbocharger
n(p_{T}) rotational speed as a function of the charge pressure of the exhaust gas turbocharger
HR altitude reserve
R reserve quantity
RB regulation area of the Venturi nozzle
p_{T} charge pressure of the exhaust gas turbocharger
p_{UM} ambient pressure
α opening angle of the Venturi nozzle

1. An internal combustion engine having:
an intake system, comprising:
an intake line that connects an air filter to a compressor,
an air supply line that connects the compressor to an inlet of the internal combustion engine, and
a throttle valve arranged in the air supply line, and
a fuel tank, having a venting line that connects the fuel tank to an activated carbon canister containing an activated carbon filter,
wherein a conveying line branches off from the air supply line and connects the air supply line downstream from the compressor and upstream from the throttle valve to the intake line downstream from the air filter and upstream from the compressor,
wherein a control valve and a Venturi nozzle are arranged in the conveying line,
wherein the activated carbon canister is connected via a first flushing line to the air supply line downstream from the throttle valve and upstream from the inlet of the internal combustion engine, and
wherein the activated carbon canister is connected via a second flushing line to the Venturi nozzle in the conveying line.

2. The internal combustion engine according to claim 1, wherein the control valve is arranged in the conveying line upstream from the Venturi nozzle.

3. The internal combustion engine according to claim 1, wherein the control valve is arranged in the conveying line downstream from the Venturi nozzle.

4. The internal combustion engine according to claim 1, wherein the compressor is configured as an electrically or mechanically driven compressor.

5. The internal combustion engine according to claim 1, wherein the internal combustion engine is charged by means of an exhaust gas turbocharger, whereby the compressor is driven by a turbine situated in an exhaust gas channel of the internal combustion engine.

6. The internal combustion engine according to claim 5, wherein the turbine has an electrically regulated wastegate via which an exhaust gas stream can bypass the turbine of the exhaust gas turbocharger.

7. The internal combustion engine according to claim 1, wherein the first flushing line and the second flushing line have a shared line section, whereby a tank venting valve is arranged in the shared line section of the two flushing lines.

8. The internal combustion engine according to claim 1, further comprising a first non-return valve arranged in the first flushing line and a second non-return valve arranged in the second flushing line.

9. The internal combustion engine according to claim 1, further comprising a tank venting valve arranged in the first flushing line downstream from a branch of the first flushing line leading out of the second flushing line as well as upstream from the feed site of the first flushing line leading into the air supply line.

10. The internal combustion engine according to claim 1, wherein the first flushing line and the second flushing line run separately from each other along their entire lengths, whereby a tank venting valve is arranged in the first flushing line.

11. A method for the regeneration of an activated carbon filter in a tank venting system of a fuel tank of an internal combustion engine according to claim 1, comprising:
generating, by the throttle valve, a negative pressure by means of which a first flushing flow is initiated which feeds the fuel vapors that were trapped in the activated carbon filter into the air supply line downstream from the throttle valve and upstream from the inlet, and
initiating, by the Venturi nozzle, a second flushing flow which feeds the fuel vapors trapped in the activated carbon filter into the intake line downstream from the air filter and upstream from the compressor.

12. The method for the regeneration of an activated carbon filter according to claim 11, further comprising adjusting the flushing quantity of the second flushing flow by means of the control valve.

13. The method for the regeneration of an activated carbon filter according to claim 11, further comprising raising the rotational speed of the exhaust gas turbocharger in order to increase the flushing quantity of the second flushing flow.

14. The method for the regeneration of an activated carbon filter according to claim 11, further comprising using a reserve area RB of the exhaust gas turbocharger to effectuate an increase in the flushing mass flow (\dot{m}_{TE}) as a function of the flushing demand and, at the same time, to actuate the control valve in such a way that the requested additional flushing quantity is systematically assigned to the flushing mass flow (\dot{m}_{TE}).

15. The method for the regeneration of an activated carbon filter according to claim 11, wherein the tank venting valve controls the first flushing flow.
